(19) United States
(12) Patent Application Publication
(10) Pub. No.: US 2017/0357940 A1
(43) Pub. Date: Dec. 14, 2017

(54) METHOD AND SYSTEM FOR DYNAMIC INVENTORY CONTROL

(71) Applicant: Customer Analytics, LLC, Verona, WI (US)

(72) Inventor: Ganesan Radhakrishnan, New Albany, OH (US)

(73) Assignee: Customer Analytics, LLC, Verona, WI (US)

(21) Appl. No.: 15/616,032

(22) Filed: Jun. 7, 2017

Related U.S. Application Data
(60) Provisional application No. 62/347,359, filed on Jun. 8, 2016.

(51) Int. Cl. G06Q 10/08; G06Q 50/30

(52) U.S. Cl. CPC G06Q 10/0875; G06Q 50/30

(57) ABSTRACT

A method and system for dynamic inventory control of a warehouse is provided that includes, receiving consumption data for a product, standardizing the consumption data to provide a data record, at least one of populating or appending a data table with at least a portion of the data in the standardized data record, wherein the data table includes a plurality of time dependent data values, calculating a flow dynamics vector for the first time t using the data values in the data table, receiving the flow dynamics vector and generating a figurative state-space diagram that is divided into a plurality of zones by a plurality of threshold values related to the product, and evaluating the flow dynamics vector in the context of the thresholds to identify the zone indicated by the flow dynamics vector.

### CROSS-REFERENCE TO RELATED APPLICATION

This application claims priority to U.S. Provisional Patent Appl. No. 62/347,359 filed on Jun. 8, 2016, the disclosure of which is incorporated herein by reference in its entirety for all purposes.

### RELATED FIELD

The method and system for dynamic inventory control relates to inventory systems.

### BACKGROUND

A warehouse plays an important role of intermediate repository between a customer and a manufacturing plant in a supply chain. One purpose of such a repository is to act as a buffer that protects the supply chain by smoothing out the vagaries of market demand of products. In this sense, a warehouse acts as the source or the supplier of goods to the market place. Replenishment processes in the supply chain backfills the warehouse with products by either in-house manufacturing or by procuring it from external vendors. Changes in the market dynamics, coupled with production lead times and delays, exacerbated by execution limitations of vendors can result in exhaustion of product(s) leading to loss of revenue. Prior art strategies in managing inventory and capacity of a warehouse have been demonstrated as inadequate for identifying a current and optimal model for stocking products. Referring to FIG. 1A, a block diagram of a typical product cycle A, includes production of a product at one or more production sources B, storage at a warehouse C, transportation and distribution D to move the product to retail distribution centers and storage E, and finally to the customer F. For the reasons stated above, such a typical system can operate in a rather mechanical fashion, with a substantial amount of guesswork and missteps with regard to stocking the warehouse C adequately. As such a method and system for optimizing inventory control is desired.

### BRIEF SUMMARY

In at least some embodiments, a method and system for dynamic inventory control of a warehouse is disclosed that includes, receiving consumption data for a product at a data storage device, wherein the consumption data includes a product identification and a quantity of the product consumed in at a first time t; standardizing the consumption data via one or more processing devices at a data handler to provide a data record, wherein the data handler verifies that the product ID correlates with a known product ID stored in a warehouse dynamics database; receiving the standardized data record from the data handler at an instantaneous dynamics calculator; at least one of populating or appending a data table with at least a portion of the data in the standardized data record, and wherein the data table includes a plurality of time dependent data values that include a beginning inventory quantity and an ending inventory quantity of the product stored in the warehouse at the first time t, wherein the beginning inventory quantity is equal to the ending inventory quantity of the product at a second time t−1; calculating via one or more processing devices, a flow dynamics vector for the first time t using the data values in the data table, wherein the flow dynamics vector includes both a measure of magnitude of change in the inventory of the product and a direction of change in the inventory, where a positive direction of change indicates inventory growth and a negative direction of change indicates inventory shrinkage; receiving the flow dynamics vector at a flow dynamics controller; and generating via the one or more processing devices, a figurative state-space diagram that is divided into a plurality of zones by a plurality of threshold values related to the product, wherein the plurality of threshold values include a low consumption rate threshold and a high consumption rate threshold situated along a first axis of the state-space diagram, and a low normalized inventory quantity threshold and a high normalized inventory quantity threshold situated along a second axis of the state-space diagram, and evaluating at the flow dynamics controller, the flow dynamics vector in the context of the thresholds to identify the zone indicated by the flow dynamics vector.

In at least some other embodiments, a method and system for dynamic inventory control of a warehouse is disclosed that includes, receiving consumption data for a product at one or more data storage devices, wherein the consumption data includes a product identification and a quantity of the product consumed in a first time t; standardizing the consumption data via one or more processing devices to provide a data record, wherein the one or more processing devices verifies that the product ID correlates with a known product ID stored in an warehouse dynamics database; receiving the standardized data record from the one or more processing devices and at least one of populating or appending a data table with at least a portion of the data in the standardized data record, and wherein the data table includes a plurality of time dependent data values that include a beginning inventory quantity and an ending inventory quantity of the product stored in the warehouse at the first time t, wherein the beginning inventory quantity is equal to the ending inventory quantity of the product at a second time t−1; calculating via one or more processing devices, a flow dynamics vector for the first time t using the data values in the data table, wherein the flow dynamics vector includes both a measure of magnitude of change in the inventory of the product and a direction of change in the inventory, where a positive direction of change indicates inventory growth and a negative direction of change indicates inventory shrinkage; generating via the one or more processing devices, a figurative state-space diagram that is divided into a plurality of zones by a plurality of threshold values related to the product, wherein the plurality of threshold values include a low consumption rate threshold and a high consumption rate threshold situated along a first axis of the state-space diagram, and a low normalized inventory quantity threshold and a high normalized inventory quantity threshold situated along a second axis of the state-space diagram, and evaluating at the flow dynamics controller, the flow dynamics vector in the context of the thresholds to identify the zone indicated by the flow dynamics vector; identifying one or more signals to be generated in response to the zone indication, wherein the identification includes comparing the zone indication with a plurality of pre-established correlative signals for the product, and wherein the one or more signals can be chosen for one or more correlative recipients; and generating the one or more signals and communicating the one or more signals to the one or more correlative recipients.

### BRIEF DESCRIPTION OF THE DRAWINGS

Embodiments of the method and system for dynamic inventory control are disclosed with reference to the accompanying drawings and are for illustrative purposes only. The method and system for dynamic inventory control is not limited in its application to the details of construction or the arrangement of the components illustrated in the drawings. The method and system for dynamic inventory control usage is capable of other embodiments or of being practiced or carried out in other various ways. In the drawings:

FIG. 1A illustrates a block diagram of a typical product cycle;

FIG. 1B illustrates a block diagram of an exemplary dynamic inventory control system for enhancing a product cycle;

FIG. 2 illustrates a block diagram of the warehouse dynamics engine and various interconnections to elements within the dynamic inventory control system of FIG. 1B;

FIG. 3A illustrates an exemplary flow of a product in and out of buckets representing a warehouse;

FIG. 3B illustrates a representation of quantity thresholds for an item stocked in a warehouse represented by bucket B;

FIG. 4 illustrates an exemplary state-space diagram;

FIG. 5A illustrates a first portion of an exemplary data table for storing dynamics data;

FIG. 5B illustrates a second portion of the exemplary data table of FIG. 5A;

FIG. 6 illustrates an exemplary flow chart for providing dynamic inventory control;

FIG. 7 illustrates another exemplary state-space diagram representative of data in FIGS. 5A and 5B; and

FIG. 8 illustrates an exemplary closing inventory position scatter plot representative of data in FIGS. 5A and 5B.

### DETAILED DESCRIPTION

A typical warehouse can store anywhere from thousands to hundreds of thousands of goods (i.e., products, parts, etc.) at a time, depending on the size of the retailer. Owners and operators of such warehouses strive to obtain an optimal level of stocked goods to fulfill downstream needs on a timely basis, while limiting excessive stockpiling of goods, which requires increased storage space and can result in unnecessary redundancy and an unwanted supply of obsolete goods. The method and system described herein discloses embodiments for optimizing a level of stocked good for a warehouse.

In at least some embodiments, the method and system described herein utilizes a fluid-dynamic based approach to manage a finite capacity of a warehouse. In this manner, a warehouse is modelled as a collection of reservoirs/buckets, with a flow of goods in and out of the warehouse represented as continuous fluid streams obeying a flow model. Such modeling can transform the optimal stocking of a warehouse into a control problem, in which the combination of the current state of the warehouse and the instantaneous flow rate (consumer consumption)—both direction and magnitude, combined with a planned incoming and outgoing of goods into the warehouse, determines the desired control action of additional procurement, suspension, or delay of goods. In at least some embodiments, the term “product” can be understood to represent the product 107, which can include any one of various types of goods that are shipped to, stored in, and shipped from a warehouse, and that are in condition for consumer sale. The term “goods” is intended to be exemplary of any one or more of numerous types of items, including for example, articles of manufacture, including assembled, disassembled, and in sub-component forms, as well as articles of nature (e.g., fruit, plants, herbs) processed or unprocessed. In at least some embodiments, the term good(s) can be understood to include finished products and parts thereof.

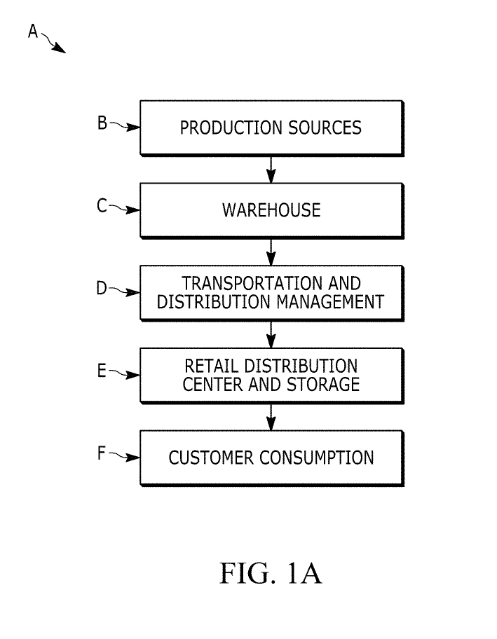

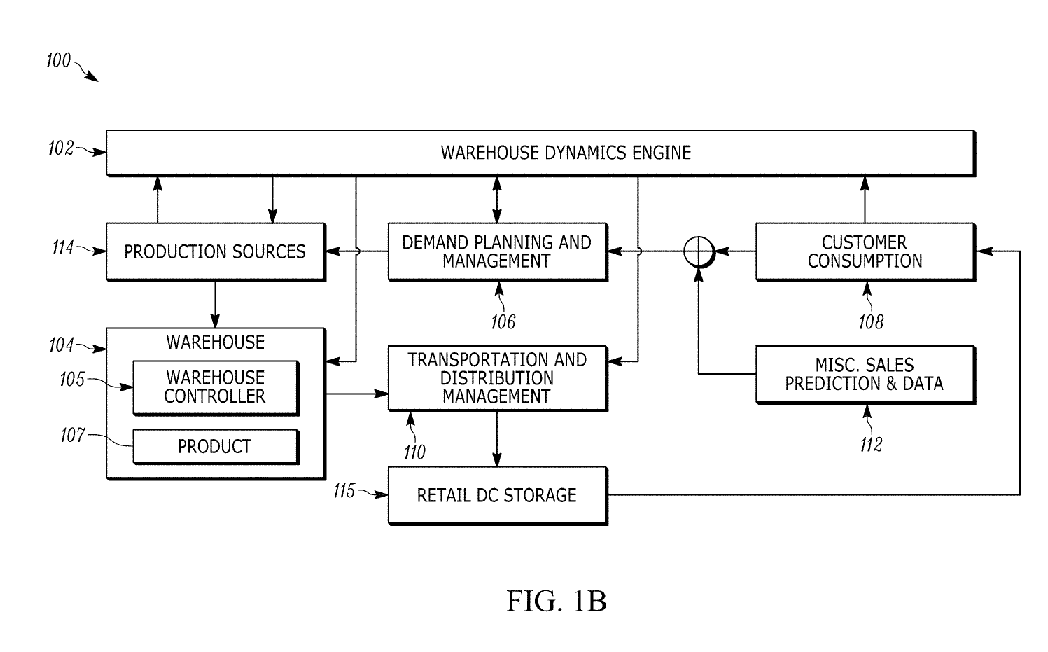

Referring to FIG. 1B, a block diagram of an exemplary dynamic inventory control system 100 is illustrated. The dynamic inventory control system 100 includes a warehouse dynamics engine 102 and several functional elements, which can be internally or externally related. In at least some embodiments, the various elements of the dynamic inventory control system 100 can include the warehouse dynamics engine 102, a warehouse 104 and associated warehouse controller 105, demand planning and management 106, customer consumption data 108 (e.g., order/sales data from online retailers, brick and mortar stores, etc.), transportation and distribution management 110, miscellaneous sales prediction data 112 (derived based on factors such as weather fluctuations, economic conditions (e.g., local housing starts), GDP, etc.), production sources 114, and retail distribution center and storage facilities 115. The dynamic inventory control system 100 can include other elements, such as additional elements, or omit some elements based on the origination of a good, how it is sold, marketed, tracked, stored, consumed, etc. The exemplary functional elements described herein as in communication with the warehouse dynamics engine 102 are intended to provide illustrative examples, which can include or exclude various functions in each, which may be commonly found in the art. For example, transportation and distribution management typically includes planning the physical movement of a product 107 from a warehouse 104 to other sales points in a distribution chain (e.g., a consumer's home or a retailer's distribution and storage center), which can occur in various ways, such as via mail, semi-tractor, delivery truck, etc. Further by example, production sources 114 typically include entities that participate in the production and assembly of the completed product, such as manufactures of individual parts for the product 107 and assembly plants. The warehouse 145 includes the warehouse controller 105, which is utilized by personnel to monitor, and, at least in some embodiments, control the flow of goods in the warehouse 104, wherein warehouse(s) 104 can include one or more physical structures used to temporarily store products. In at least some embodiments, the warehouse controller 105 can include a processor, a memory unit, and a machine-readable storage medium. Further, in some embodiments, the warehouse controller 105 can be configured to operate across a shared network to interconnect a plurality of warehouses 104, with the shared network including various typical network components, such as servers, databases, operator terminals, etc. Reference to inputs and outputs to and from the warehouse 104 are to be understood as occurring via communications with the warehouse controller 105.

The warehouse dynamics engine 102 interacts with the elements of the dynamic inventory control system 100 to receive input data and to transmit data and signals. The warehouse dynamics engine 102 can take the form of a software program (machine language, executable code, machine instructions, etc.) resident on a tangible medium, such as a hard drive or memory that is utilized by one or more computational units, such as a processor, and in communication with various sources of data. Using various sources of input data, such as the customer consumption data 108, the warehouse dynamics engine 102 can formulate the desired inventory control signals to send to other elements. The input data from the elements of the dynamic inventory control system 100 can be instrumental in providing information needed to identify recommendations for signals. For example, customer consumption data 108 can include customers or customer groups, distribution centers acting as a proxy to online customers, and retail stores, which consume goods from the warehouse 104 from time to time. During the time interval of interest (e.g., days, weeks, or months), they can report the quantity consumed at some pre-defined periodicity or upon a request from the warehouse dynamics engine 102. Further, in some instances, individual customers can order items for consumption. This is particularly true for expensive and/or large items like furniture. These orders can eventually end up in the demand planning and management 106. Demand planning and management 106 can be a functional device that stores future committed orders from individual customers, speculative predicted orders from retail distribution center and storage facilities 115. It can also store associated metadata such as average orders from specific customer groups and additional statistical metrics. These can be stored in a database, which can include a machine-readable storage medium such as read-only memory (ROM), random-access memory (RAM), magnetic disk storage media, optical storage media, flash-memory devices, and/or similar storage media. Exemplary contents and arrangement of data utility and storage will be described below.

Planning elements such as transportation and distribution management 110, and production sources 114, can also generate or trigger actions in the dynamic inventory control system 100. For example, transportation and distribution management 110 can be responsive to a signal from the warehouse dynamics engine 102, to move goods out of the warehouse 104. Similarly, production sources 114 can induce actions based on signals from the warehouse dynamics engine 102 that increase or decrease production at a production source, such as an assembly plant. Demand planning and management 106 can also modify the shipments from a vendor, the quantities of finished products, parts, and raw-materials, thus attempting to alter the dynamics in the desired direction (e.g. reduction or increase in the production and/or shipment of goods).

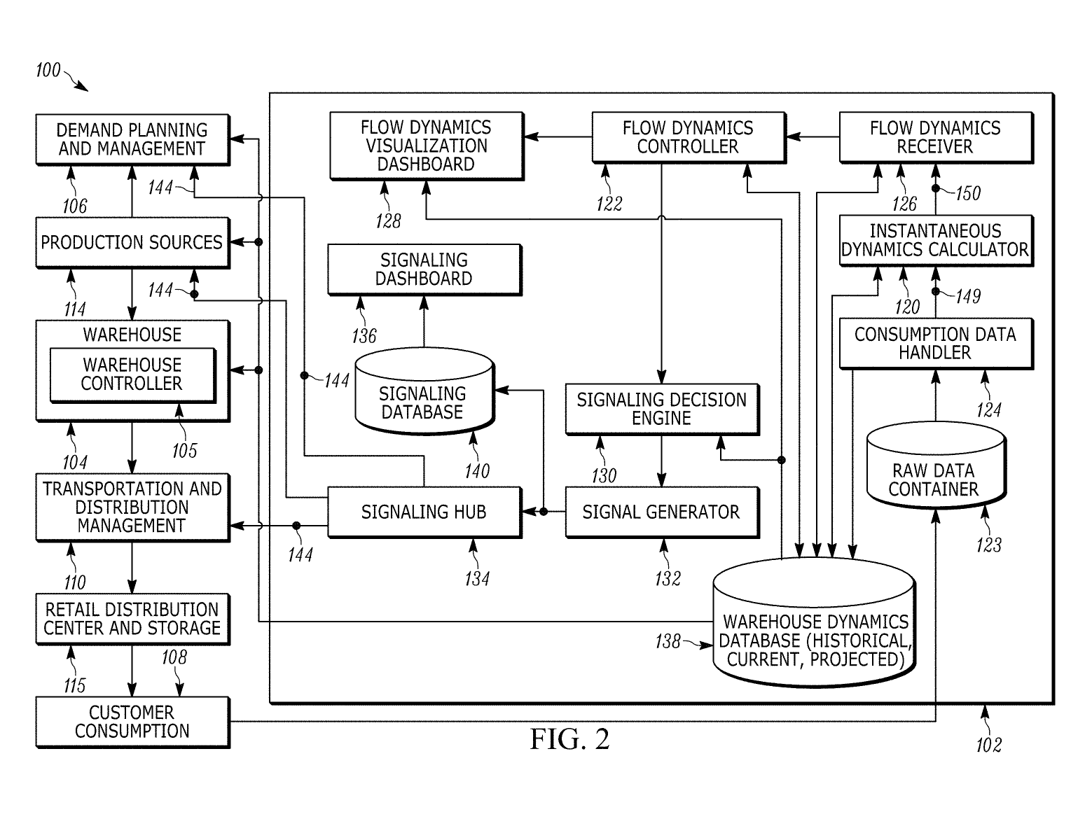

Referring to FIG. 2, a block diagram is provided that further illustrates the warehouse dynamics engine 102 and the various interconnections to elements within the dynamic inventory control system 100. The warehouse dynamics engine 102 can include multiple functional components, such as an instantaneous dynamics calculator 120 and a flow dynamics controller 122. The instantaneous dynamics calculator 120 is configured for implementing a mathematical flow model as described herein. The flow dynamics controller 122 can identify recommendations of signals based on the mathematical flow model and/or other data. Computed flow dynamics, historical flow dynamics, and a formulated view of the flow dynamics can provide input data points for signal generation. Various signals can be generated by a signaling system based on the behavior of the warehouse dynamics engine 102 and predefined rule sets, and the signals produced can be communicated to other elements, such as elements 106, 110, and 114.

As shown in FIG. 2, the warehouse dynamics engine 102 can include various components that can be realized by hardware or machine-executable instructions. Further, various components can share hardware resources. For example, the components can share a single processor or each component can run in its own virtual machine in the cloud or other local or network machine. In at least some embodiments, the various components shown as forming part of the warehouse dynamics engine 102 can include a raw data container 123, a consumption data handler 124, the instantaneous dynamics calculator 120, a flow dynamics receiver 126, the dynamics controller 122, a flow dynamics dashboard 128, a signaling decision engine 130, a signal generator 132, a signaling hub 134, a signaling dashboard 136, an warehouse dynamics database 138, and a signaling database 140. The databases 138 and 140 can be one or more of a simple relational databases, a file systems, and a NoSQL database that can be deployed in a single server or clustered configurations, in place of a traditional database.

The raw data container 123 receives the customer consumption data 108 from various sources that account for customer consumption (stores, online sales, etc.) of specific products or product groups. The received data can be pristine data from other supply chain systems (not shown) in their native form through ETL (Extract Transform and Load) or other methods such as manual file transfer. More particularly, the customer consumption data 108 is presented to the raw data container 123 in numerous possible forms, which can then require further processing, although the customer consumption data 108 generally includes specific product identifications (e.g., a product ID) and consumed quantities of the product. The data handler 124 is a component that can perform data standardizations (transform to a desired common formatting, etc.) for example, stripping, padding characters, data type conversions such as integer to Boolean, etc., among other operations. The data handler 124 can support additional normalization operations as the situation demands, such as case conversion. The data handler 124 confirms the product IDs are valid, based on cross-references to the product knowledge data in the warehouse dynamics database 138, and then passes on the standardized consumption data 149, which includes specific product IDs and quantities thereof to the instantaneous dynamics calculator 120 for flow dynamics processing.

The instantaneous dynamics calculator 120 can include hardware and/or executable instructions on a machine-readable storage medium. Upon receiving the standardized customer consumption data 108 from the data handler 124, the instantaneous dynamics calculator 120 computes a flow dynamics vector 150 for the specific product identified, as described below in equations (2) through (8). The flow dynamics vector 150 provides a primary indicator that is used to determine what actions should be taken to optimize warehousing of a specific product (e.g., a specific product ID) as discussed in greater detail below. These computations can alter both current flow dynamics as well as the projected flow dynamics and can include sending and receiving historical, current, and projected flow dynamics data. Calculating instantaneous flow dynamics data involves computations including: congestion y(t) representing incoming inventory, held inventory q(t); fluid height h(t) representing the a normalized quantity of the congestion y(t), inventory growth (or exhaustion) rate h′(t), as described in equations (1), (2), and (3) (as provided below), where ‘t’ is the current step (or the most recent step) of the calculation. In the context of the projected values of incoming and outgoing products data from demand planning and management 106 and production sources 114, the projected flow dynamics data can be calculated for future steps, times t+1, t+2, t+3, t+k, where in at least some embodiments ‘k’ can be an integer, like 10, and wherein each possible value of k, stands for a time interval with units of days, weeks, etc. The flow dynamics vector at ‘t’ for the interval t, t+k can be calculated as the pair: (q(t), h′(t+k)). At each step ‘t’, the set of all flow dynamics vectors for all possible intervals t, t+k can be calculated for interested values of ‘k’. The growth component h′ of the flow dynamics vector can be expressed as a fraction or as a percentage. Note that the growth component of the flow dynamics vector has two parts, (a) magnitude of change given by the absolute value of h′, and (b) direction of change given by the sign of h′ where, a positive value stands for growth and a negative value indicates shrinkage (i.e. depletion, reduction, exhaustion). As time passes, the flow dynamics calculations are performed for each time interval, with the current values becoming historical values.

The instantaneous dynamics calculator 120 then provides the computed set of flow dynamics vector(s) 150 to the flow dynamics receiver 126. The flow dynamics receiver 126 can include hardware or executable instructions on a machine-readable storage medium configured to retrieve previously-calculated dynamic vectors and other flow dynamics data for a particular product ID in the warehouse dynamics database 138. The presently computed flow dynamics data values including the flow dynamics vectors 150 can be stored in the warehouse dynamics database 138 for future calculations. In at least some embodiments, the flow dynamics vectors 150 can be mathematically rounded up or down to facilitate ease of performing calculations at the flow dynamics controller 122. The flow dynamics receiver 126 passes the flow dynamics vector 150, in the chosen rounded or unrounded format, to the flow dynamics controller 122. This can be direct or indirectly through the warehouse dynamics database 138. In addition, the flow dynamics receiver 126 can transmit a request for triggering control evaluations to the flow dynamics controller 122.

The warehouse dynamics database 138 can be comprised of one or more computational hardware components and machine-readable storage mediums configured as a centralized node or distributed over a local network. The warehouse dynamics database 138 can host at least one programmable interface, which can be basic, supporting basic CRUD (create, read, update, and delete) operations, or can be sophisticated, enabling client specific codes to be deployed for execution towards one or more elements of the warehouse dynamics engine 102, such as the signaling decision engine 130, or one or more components outside of the warehouse dynamics engine 102 itself, but still in the dynamic inventory control system 100, such as the warehouse 104, production sources 114, and demand planning and management 106. In various embodiments, wherein the flow dynamics controller 122 includes the warehouse dynamics database 138, database 138 can include an internal system interface such as an ATA or SCSI device, or an operating system with inter-process communication functionality that enables data exchange. In various embodiments, the warehouse dynamics database 138 can share at least some of the components of the warehouse dynamics engine 102 in order to facilitate data exchange and interpretation. The calculation of the flow dynamics vectors 150 and other flow dynamics data as performed by the instantaneous dynamics calculator 120 is discussed below, detailing a fluid-dynamic based approach.

Warehouse processing involves processes such as stocking products in shelves or sending products to other places—either to an end customer, or to a store, or to another warehouse. The costs associated with these operations are bundled into the operating costs of holding the products (inventory). Owners and operators of warehouses for goods strive to obtain an optimal level of stocked goods to fulfill downstream needs on a timely basis, while limiting excessive stockpiling of goods, which requires increased storage space and can result in unnecessary redundancy and an unwanted supply of obsolete goods. To strive towards an optimally stocked warehouse, a fluid-dynamic based approach can be utilized, wherein a warehouse is modeled as a collection of buckets, and where each bucket represents space in the warehouse for receiving a specific product. Multiple product sources (e.g., production facilities, vendors, manufacturers, etc.) add products into the bucket, with each product source treated as a separate flow of fluid into the bucket. The flow of fluid into a bucket is understood to be analogous to the flow of products into a warehouse space.

The fluid-dynamic based approach is discussed below as an exemplary model, wherein in at least some embodiments, for each bucket the following assumptions are provided: (i) All flows are homogeneous—meaning that all flows into the buckets undergo the same processing (typically different buckets could undergo different sets of treatment); (ii) Arrivals are mutually independent—meaning that there are no constraints imposed by this model among different flows and the processing order is dependent only on the time of arrival of the product and is treated as FIFO (First In-First Out), although typically it is very likely that a stocked product can stay on the shelf much longer than an item arriving much later in time due to positioning; this is particularly true for nonperishable items. The model outlined here accounts for this assumption in the calculation of effective holding time; (iii) The cost of processing a unit volume of fluid (one product unit) is constant and is independent of the flow; (iv). Generally, while not necessary, the flows are not prioritized; if prioritized, it changes the FIFO processing order which impacts arrival time and this in turn affects the holding time calculations.

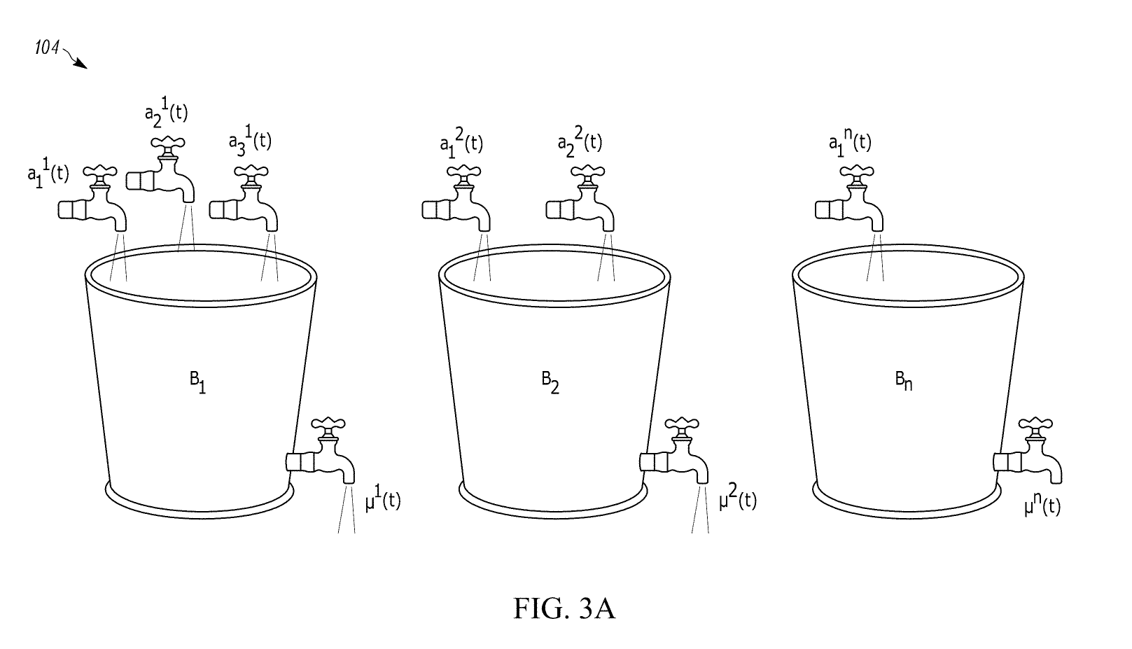

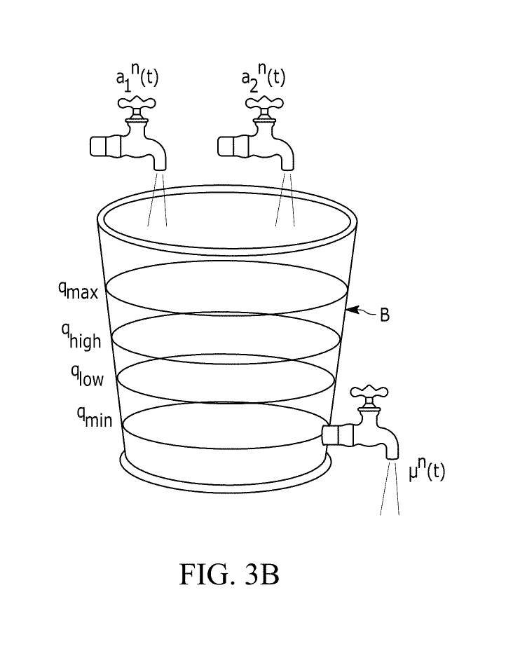

Referring to FIG. 3A, buckets B1 and B2 are illustrated, with each representing an exemplary flow of a product in and out of the warehouse 104. While the figure depicts each bucket having many incoming flows and one outgoing flow, there can be many outgoing flows and one incoming flow as well without loss of generality of the model calculations. It is to be understood that a plurality of buckets B could be included and that only two are discussed for convenience, not because of a limitation of the methods disclosed herein.

For each bucket B, at time ‘t’, we can define:
aᵢ(t)—Arrival rate of i^{th} flow of a fluid from each source into the bucket;
y(t)=Σᵢaᵢ(t)—Congestion as the rate at which the fluid builds up at the bucket;
μ(t)—The consumption rate; the total amount of (units of) fluid that flows out of the bucket in a unit time (i.e., the quantity of product that leaves the warehouse in the unit of time t);
I(B)—The set of flows that pass through a bucket (B);
q(t)—The instantaneous length of the input queue (quantity of fluid);
l(t)—Average latency of fluid arriving at time ‘t’;
   Under steady state, for each bucket B, the following identities hold:

Congestion: y(t)=Σ_{iεI(B)}aᵢ(t) (1)

Height of incoming fluid: h(t)=y(t)/(μ(t) (2)

Quantity of fluid: q(t)=q(t−1)+y(t)−μ(t) (3)

where, q(t−1) is the queue length in the previous unit of time;

Rate of growth: h′(t)=d/dt(h(t))=(y(t)/μ(t))−1 (4)

For q(t−1)=0

h′(t)=max{y(t)/μ(t)−1,0} (5)

For q(t−1)>0,

h′(t)=(y(t)/μ(t))−1 (6)

Equation (5) describes the dynamics when the queue is empty. It states that the queue will remain empty if the aggregate arrival rate of fluid is equal to the consumption rate, and fluid will build up if the consumption rate is less than the instantaneous aggregate arrival rate of all incoming flows. Equation (6) describes the non-empty queue scenario.

From the equations, it can be seen that for positive values of h′, q(t) increases, and for negative values for h′, q(t) decreases. Thus, h(t) represents the instantaneous holding-time at a bucket B (i.e., delay the fluid entering the bucket B would experience before leaving the bucket B.) In the modeled type of flow, (FIFO), h(t) represents the nominal latency of a product at time t.

If one were to treat the incoming flows separately, consumption can be written as:

μ(t)=Σ_{iεI(B)}μᵢ(t) (7)

From equation (4),

μᵢ(t)=aᵢ(t)/(h′(t)+1) (8)

Equation (8) represents the departure rate of the i^{th} flow.

In this section, we discuss how the model described above can be applied for optimal management of inventory in a warehouse. Acting as a buffer, the role of a warehouse is to smooth out the vagaries of demand. Therefore, retailers attempt to stock the warehouse with an adequate number of each item type so that one does not lose a sale during seasons of acute demand, and yet not maintain high levels of inventory to maintain a high margin. Thus, from the perspective of supply, the word optimal means that the quantity of an item stocked in the warehouse is maintained within a limited range, which are represented herein by terms q_{high} and g_{low}. With reference to exemplary bucket B shown in FIG. 3B, q_{high} and g_{low} indicate the upper and the lower boundaries of this desired range, respectively, and qₘₐₓ and qₘᵢₙ represent chosen maximum and minimum quantity capacity for the warehouse. As evident in this perspective, at time ‘t’, each bucket B, is in one of the following mutually exclusively states:

Overfilled: q(t)≧q_{high}

Optimally-filled: g_{low}<q(t)<q_{high}

Under-filled: q(t)≦q_{low}

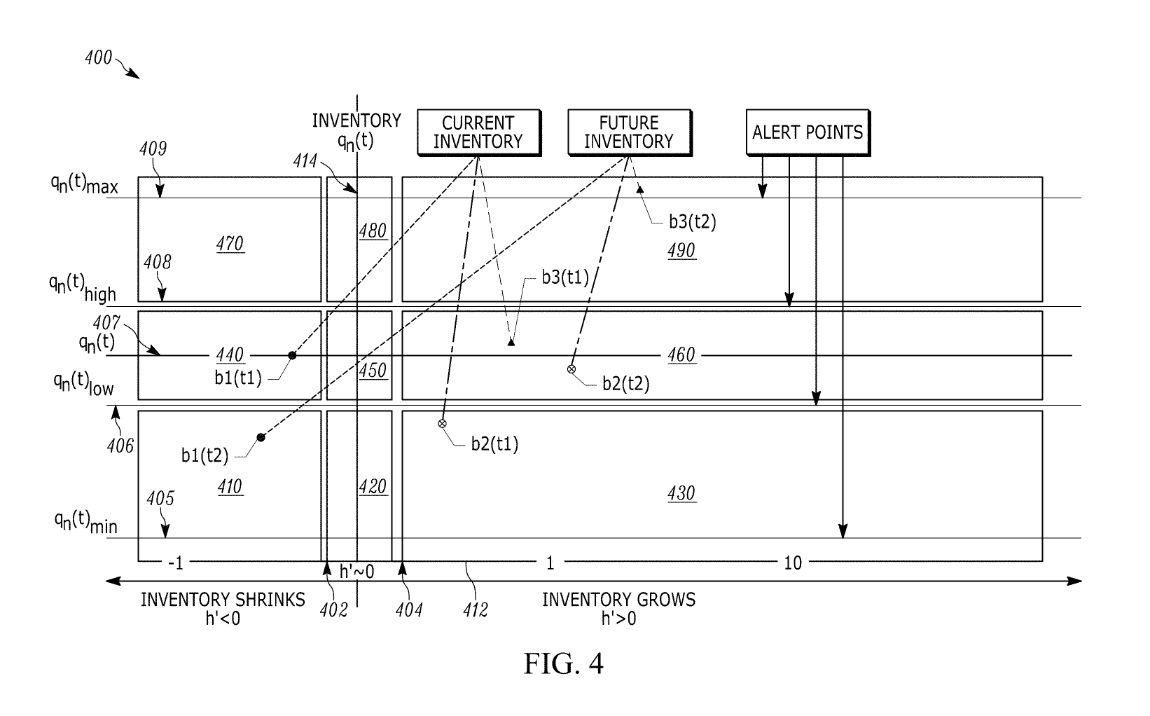

The rapidity of state change from one to another depends on both the relative magnitudes of changes of y(t) and μ(t), as well as the direction of change. The state of change can be represented in a graphical form, such as provided in FIG. 4, which provides a state-space diagram 400 illustrating exemplary flow dynamics thresholds and operating regions. State-space diagram 400 can be indicative of exemplary effects of the aforementioned thresholds along with hard coding, user definable rules, or other methods of correlating a flow dynamics vector to a set of signals to set threshold values and limits. State-space diagram 400 can include an x-axis 412 related to consumption rate (growth rate (h′)) and a y-axis 414 related to normalized inventory held (quantity stored in warehouse) as fluid height, with a normalized value of one indicating the ideal inventory condition for the given threshold, and with a value of zero for rate of consumption indicating the ideal inventory condition where the production matches the consumption. The state-space diagram 400 is utilized as a figurative diagram by the warehouse dynamics engine 102.

Recalling equation (6), which provides h′(t)=(y(t)/μ(t))−1, placing h′ along the x-axis 412, to the left of h′=0 inventory is shrinking and to its right, inventory is growing. Further, the farther away to the left or right, the greater the magnitude of change. The state at h′ (t)=0 implies a temporal equilibrium in which the input congestion matches exhaustion (i.e. the consumption rate), and the system continues to remain stable. The axis point (0, 1)—intersections of lines 407 and 414 is the ideal equilibrium point (optimal condition) where consumption equals production and current inventory level (quantity) equals the desired value. State-space diagram 400 can also include threshold lines 402, 404, 406, and 408 indicative of the low consumption rate threshold, high consumption rate threshold, low normalized inventory threshold, and high normalized inventory threshold, respectively. Together, the threshold lines 402, 404, 406, and 408 can divide the state-space diagram 400 into nine operating regions: zone A 410, zone B 420, zone C 430, zone D 440, zone E 450, zone F 460, zone G 470, zone H 480, and zone I 490.

Once we define a region of stability, intuitively, any tendency to move away from this region signifies deterioration while movement towards zone E signifies improvement. Factoring these three items—state, magnitude of change, and direction, we can define the following state-spaces:

Overfilled and improving (zone G in FIG. 4)

Overfilled but stable (zone H in FIG. 4)

Overfilled and deteriorating (zone I in FIG. 4)

Optimally-filled and stable (zone E in FIG. 4)

Optimally-filled and deteriorating (zone D and zone F in FIG. 4)

Under-filled and deteriorating (zone A in FIG. 4)

Under-filled but stable (zone B in FIG. 4)

Under-filled and improving (zone C in FIG. 4)

Inadequate inventory combined with deteriorating prognosis (zone A in FIG. 4) impacts topline sales, while excess inventory with deteriorating prognosis (zone I in FIG. 4) affects the margin adversely. Zones D and F capture optimally-filled but deteriorating situations, while zones C and G warn of impending trouble where the quantity is trending towards too little or too much. The ideal/optimal position occurs with each bucket operating with a flow dynamics vector indicated in zone E.

To provide an example of flow dynamics, three products are placed in the state-space diagram 400, with markers identified as “Beginning Inventory”. These markers can indicate the open position of that time interval (or closed position of the previous time interval), and the future positions (for a particular day) are also indicated. For clarity of the schematic, the flow dynamics vectors are not shown, but have been used to calculate the marker locations. As seen in FIG. 4, a pictorial view of the states of three buckets (products) in a warehouse, represented by markers b1(t1), b2(t1), and b3(t1) are provided. In any retail business, manufacturing/procurement is tied to the demand. Demand is typically forecast, for there is generally a lead time involved in producing/procuring a product from a production source. Hence, purchase and/or manufacturing orders are generated before the product is needed on the shelf. As a result, a retailer is aware of the estimated/expected sales and arrival of products into the warehouse. This forecasted is depicted as “Future Inventory” in FIG. 4, how the states for each bucket change with time is shown by markers b1(t2), b2(t2), and b3(t2).

As noted above, the dynamics calculations of the dynamic vectors 150 and other flow dynamics data (e.g., the data in data table 500) can be performed by the instantaneous dynamics calculator 120, which in turn provides the computed flow dynamics vector(s) 150 and other flow dynamic data (as discussed above) to the flow dynamics receiver 126, which can modify or otherwise adjust the flow dynamics vector 150 and pass it on to the flow dynamics controller 122. The flow dynamics controller 122 can include computing hardware and/or executable instructions on a machine-readable storage medium, along with a data interface to warehouse dynamics database 138 to load and store data. Utilizing the product ID and the flow dynamics vector 150, the flow dynamics controller 122 can establish a state-space mapping of markers representing threshold data for the flow dynamics parameters—including, but not limited to, the rate of change of fluid height and quantity of fluid, and can subject them to the rules specified in the signaling decision engine 130. The flow dynamics controller 122 can also push the dynamics calculations to a flow dynamics dashboard 128. The flow dynamics dashboard 128 can include hardware and machine readable instructions that enable the flow dynamics calculations to be rendered into a graphical form. The rendering can be in the form of alarms, bar and pie-charts and other visual aids that are useful to a human operator.

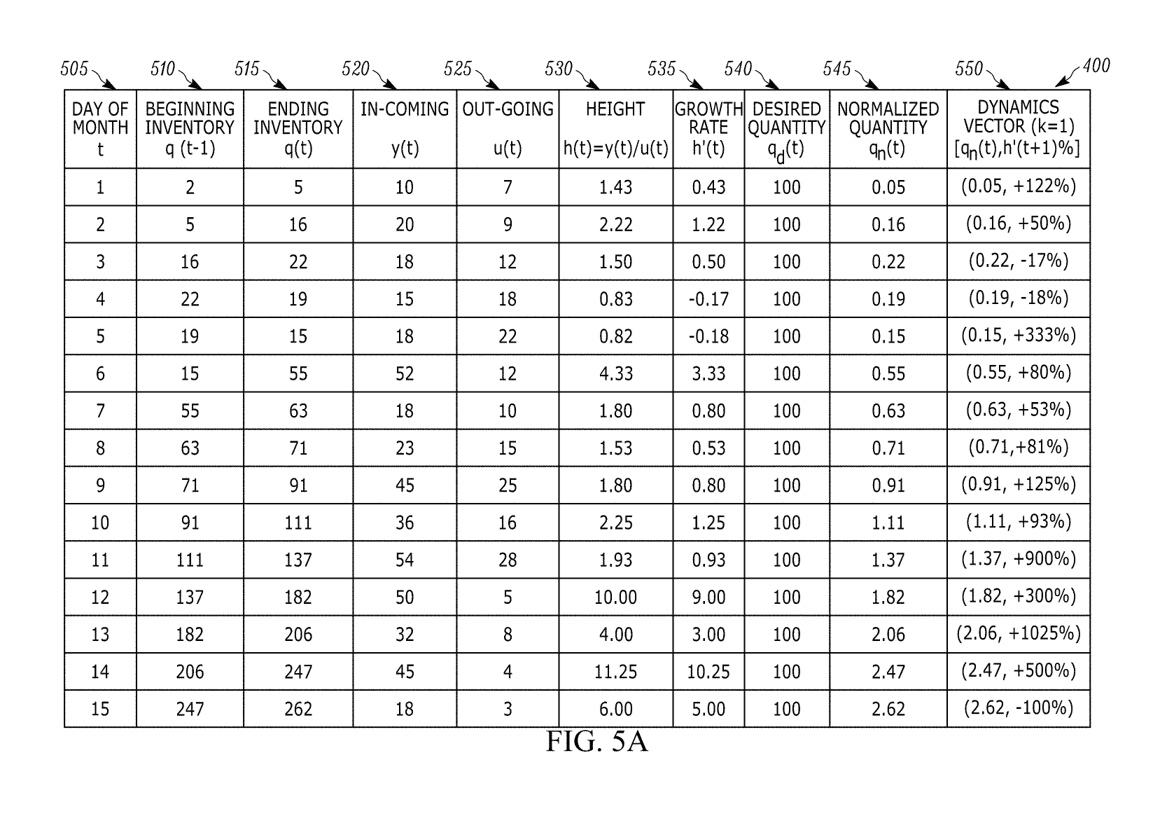

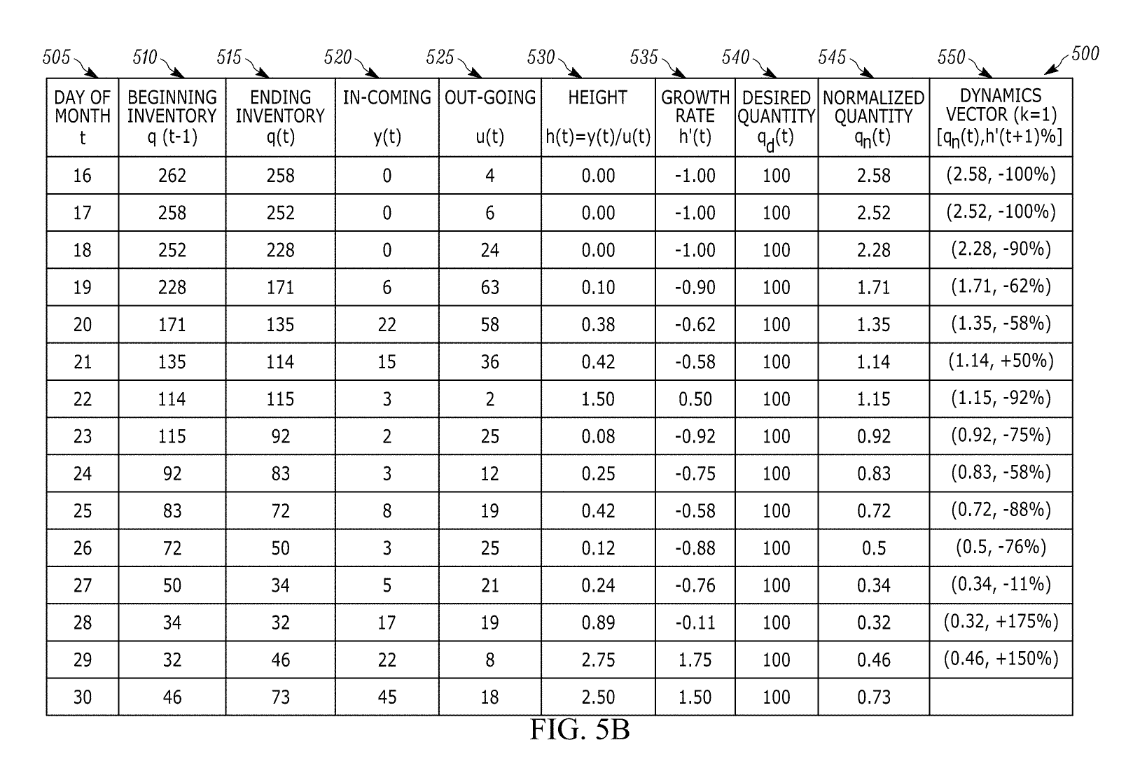

FIGS. 5A and 5B illustrate an exemplary data table 500 (data arrangement) for storing instantaneous flow dynamics data. This dynamic flow data includes values derived from the equations (1)-(8) as well as additional related information, such as the beginning inventory quantity q (t−1). Data table 500 can be implemented using a variety of data structures such as, for example, objects, arrays, linked lists, trees, and/or hash tables among others, and can be stored in, for example, warehouse dynamics database 138 of the warehouse dynamics engine 102, or another repository in the dynamic inventory control system 100. Data table 500 can include fields such as received day-of-month (timestamp) field 505, beginning and ending inventory fields 510 and 515 respectively, computed fields 530, and 535, and desired quantity (meta-data threshold) 540. It is apparent that additional fields can be stored in data table 500.

Fields 505, 510, and 515 indicate the day of arrival of data, the day's beginning, and closing inventory positions respectively. Congestion field 520 indicates a measure of the current congestion at the warehouse on that particular day; i.e., this value can indicate the total number of instances of products that arrived over the time window—a day. Service rate field 525 can store a measure of how many products were shipped out during that time window. For example, this value can indicate the number of items that left the warehouse during the time window. Fluid height field 530 can store an indication of the current height of the fluid in the bucket representing the quantity of products in the warehouse. In various embodiments, this can simply include a count of the number of product items shelved in the warehouse. Field 535, Growth Rate, can contain the computed rate of growth of fluid (i.e. the buildup or exhaustion of inventory) where positive values indicate accumulation, and negative values indicate exhaustion. Field 540, desired quantity q_{d}(t), can indicate the quantity of product that the business (warehouse owner/operator) wants to hold during a time unit interval, while field 545, normalized quantity qₙ(t), can be the ratio of the end-of-day inventory to the desired one. Field 550, Flow dynamics vector, can hold the computed instantaneous flow dynamics vector 150. It will be apparent that various variations and additional values can be stored in data table 500. As an example, assume a data record in data table 500 had been received on the eight day of a month (Timestamp field 505) with beginning and closing inventory positions of 63 and 71 (Fields 510 and 515), and the warehouse received 23 items and shipped 15 items (Fields 520 and 525) on that day. Field 540 can indicate that the desired inventory level was 100 items on that day. Fields 530, 535, 545, and 550 can be computed to hold the flow dynamics, and can indicate the values computed by the instantaneous dynamics calculator 120.

The signaling decision engine 130 (FIG. 2) can include hardware or executable instructions on a machine-readable storage medium that are used to determine an appropriate signal based on the flow dynamics and metadata (threshold data) passed in by the flow dynamics controller 122. Signaling decision engine 130 can subject the flow dynamics vector 150 to the parameters of the pre-defined zones of the state-space, such as in FIG. 4, and can have a set of pre-defined decision support rules (rule set) configured in it, which, given data context, determines what signals should be generated that are correlative with the zone indicated by the flow dynamics vector 150, and to whom the signal is correlated with based on the action indicated in the signal (e.g., a signal indicating a decrease in manufacturing would be correlated with one or more production sources). The support rules can determine that no signal should be sent or that one or more signals qualify to be generated by the signaling decision engine 130. In the process, signaling decision engine 130 can compare values of the flow dynamics vector 150 to the boundaries of the state-spaces. In doing so, the signaling decision engine 130 can determine whether the present (current) flow dynamics vector 150 falls in one of:

Overfilled and improving (zone G in FIG. 4)

Overfilled but stable (zone H in FIG. 4)

Overfilled and deteriorating (zone I in FIG. 4)

Optimally-filled and stable (zone E in FIG. 4)

Optimally-filled and deteriorating (zone D and zone F in FIG. 4)

Under-filled and deteriorating (zone A in FIG. 4)

Under-filled but stable (zone B in FIG. 4)

Under-filled and improving (zone C in FIG. 4)

For example, referring again to FIG. 4, zone F is characterized by growing inventory (fluid) at a high rate, but the current value of quantity is within the ideal range. When zone F is indicated, the pre-determined support rules in the signaling decision engine 130 can suggest that the rate of production be reduced, which can translate into two signals being generated: one that seeks to push incoming inventory to a later date, and another that can seek to reduce the in-house assembly (assembly lines, packaging plants, etc.) by a certain percent. In other circumstances, for example if the flow dynamics vector 150 was related to zone A, which characterizes a low quantity of inventory in the warehouse and shrinking, signals might be sent to production sources 114 to increase production of the product, as well as to increase orders for the necessary raw materials or parts needed to produce the product.

Generated signals 144 are then transmitted to the signal generator 132. The signal generator 132 can be a software module that translates the logical signals from the signaling decision engine 130 into protocol specific data. The protocol specific data can consist of proprietary message formats found in numerous types of electronic system, and can include for example, a header and a data payload. In at least some embodiments, a signal can consist of an originator, topic (what is the signal about), and data (specific to the context of the signal). For example if zone F has been indicated, the two signals generated can in some embodiments be:
Signal 1: originator is: “Flow Dynamics Controller”, Topic: “Reduce production rate”, the data is: “the product ID”, “Quantity to reduce for the next interval(s)”;
Signal 2: originator is: “Flow Dynamics Controller”, Topic: “Delay further product arrivals” and data can be: “Product Id”, “Delay interval—2 weeks.”

Once generated, the signal(s) can be communicated to the signaling hub 134. The signaling hub 134 can include hardware or executable instructions on a machine-readable storage medium configured to reliably transmit and handover messages to recipients. The signaling hub 134 can make use of existing messaging mechanisms like JMX, RabbitMQ, etc. or can be a proprietary system or a combination of both. The signaling hub 134 can support multiple protocols, including but not limited to HTTP, CORBA, SOAP, REST etc., and can implement a peer-to-peer paradigm or a publish-subscribe paradigm or a combination of both. Depending on the negotiated configuration, signaling hub 134 can reliably communicate signals, as noted above to various elements of the dynamic inventory control system 100, such as demand planning and management 106, transportation and distribution management 110, and production sources 114. In addition, the signaling hub 134 can store the communicated signals in the signaling database 140 and push the signals 144 to the signaling dashboard 136, which can include hardware and machine readable instructions that display the signals for viewing by a human operator. The received signals 144 provide the informative data to assist the interactive elements in making action decisions, whether based on a human suggestion or a pre-determined calculated suggestion. The signaling database 140 can include a machine-readable storage medium such as read-only memory (ROM), random-access memory (RAM), magnetic disk storage media, optical storage media, flash-memory devices, and/or similar storage media. It can support a simple CRUD interface to persist the signals emanating from the signal generator 132.

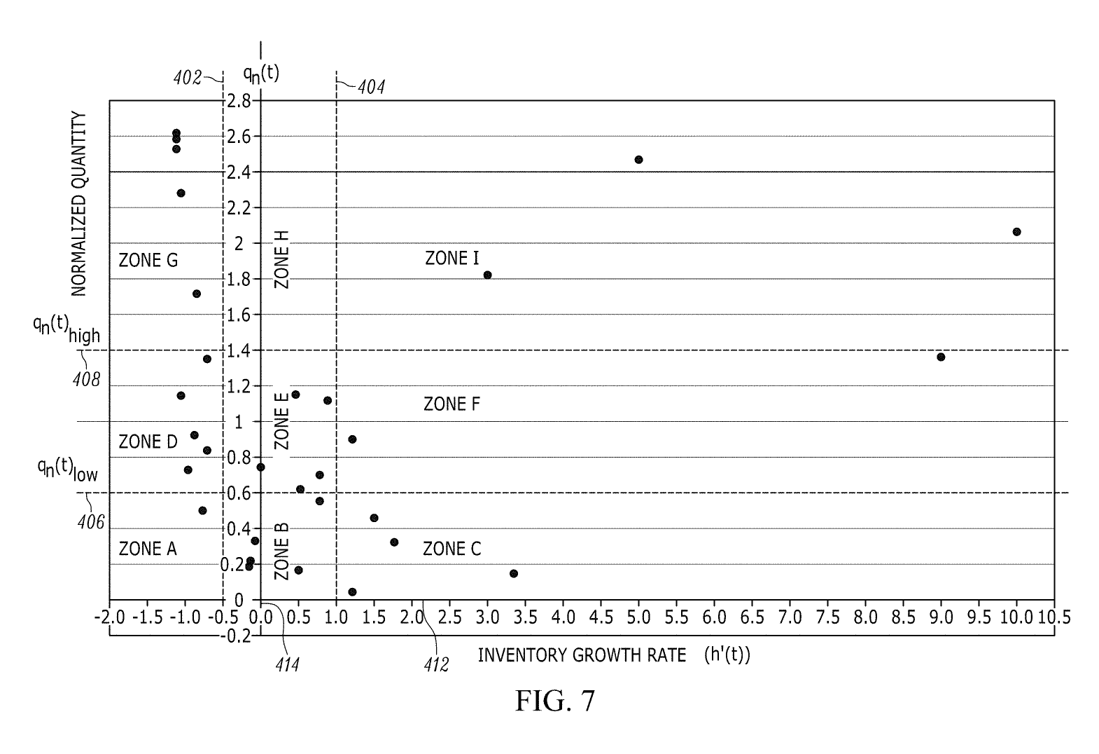

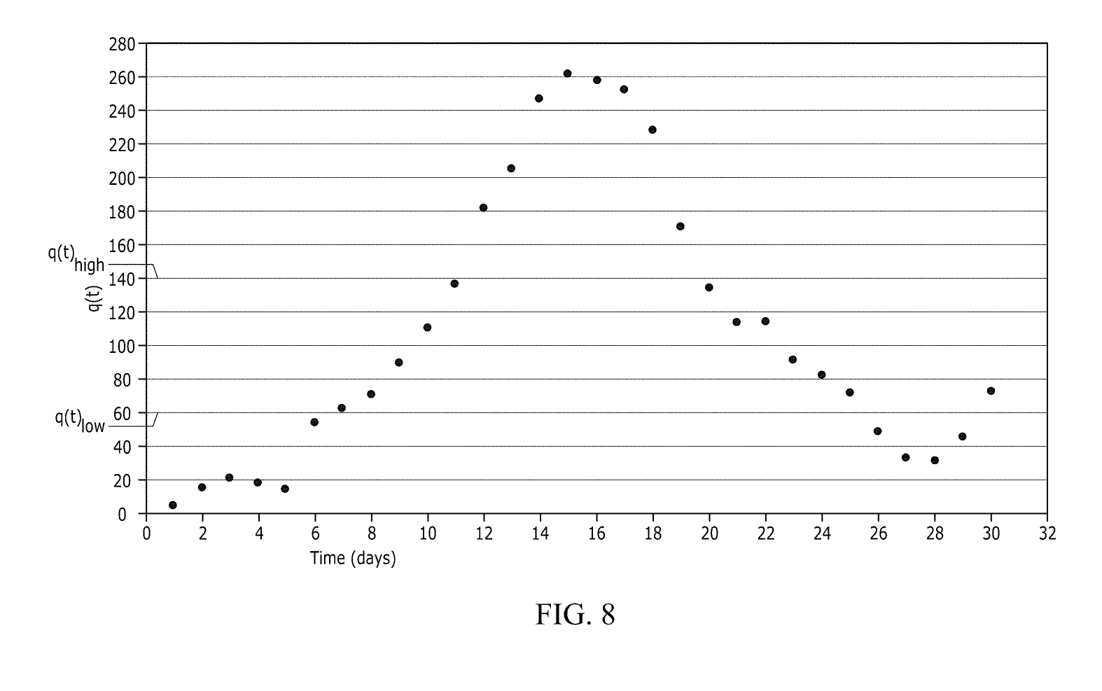

To further illustrate by example, the sample data in table 500 is used to represent the incoming and outgoing data and the expected flow dynamics computations for a fictitious product. For simplicity, in this example the following assumptions are made: (i) the desired quantity q_{d}(t) on hand for all the days of the month is 100. This is typically not true in many situations, as seasonality and other operational constraints can necessitate different values for different weeks. Also, the lower and upper bounds (qₙ(t)_{low} and qₙ(t)_{high}) for inventory are arbitrarily chosen as 40% off the desired value (namely, values 60 and 140 respectively). The lower bound of h′(t) corresponds to aggregate arrival rate at half of exhaustion rate and the upper bound of h′(t) corresponds to aggregate arrival rate at the same as the exhaustion rate. For any given day, the next few of (e.g., seven) of the predicted incoming and outgoing quantities turn out to be true when future arrives. This is again assumed for simplicity of illustration. Otherwise, having predictions for each day for the next seven days would result in managing 49 prediction values for each day. FIG. 7 is the state-space diagram for the example data of table 500 in FIGS. 5A and 5B. As shown in FIG. 7, only for a few days, five to be precise, the inventory dynamics were considered optimal. On eight occasions (zones G and I) inventory was way over the upper bound, only three of those occasions (zone I) were really of concern. Similarly, of ten occasions (zones A and C) when inventory was below the lower bound, only one of them were truly worrisome (zone A), when the inventory was too low and headed towards exhaustion. FIG. 8 is the closing inventory position scatter plot for the same data, which exemplifies the closing inventory by day. From FIG. 7, it is evident what corrective actions should be taken to strive towards an optimal level of inventory quantity and consumption rate. The calculated flow dynamics vector (FIGS. 5A and 5B) is the key that helps quantify the corrective actions as it quantifies the current and the future evolution of the state-space.

As shown in FIGS. 5A and 5B, the first component of the flow dynamics vector is the normalized inventory quantity qₙ(t) (q expected), which is defined as the ratio of on-hand q(t) to the desired inventory quantity q_{d}(t). The second component of the flow dynamics vector is the instantaneous growth rate expected in the next time unit (e.g., day) expressed as a percent (h′(t+1)%), defined as the ratio of incremental change in quantity to the instantaneous consumption rate, whose magnitude indicates the rapidity of change and the direction points to the sense of a desired inventory level.

The desired optimal position occurs when the inventory marker is kept in zone E at all times, therefore, anytime the future inventory prediction moves the marker away from zone E, corrective action to push the marker back to zone E is desired. In most cases, the corrective action will be in the form of increasing or decreasing the inflow (arrival/purchases from a vendor/manufacturer) of the product, based on the dynamics, as one would seldom want to attempt to limit outflow (consumption) of a product by customers. Equations (1) through (6) are used for this purpose. Equation (8) associates a fraction of the outflow (e.g., sales) to an inflow (e.g., purchase from a product source). Thus, to control the quantity q(t) of the fluid, one would control the arrival rates aᵢ(t) of the inflows such that the cost benefit is maximized. These corrective actions are implemented as signals that emanate from the warehouse dynamics engine 102 and sent to various elements of the dynamic inventory control system 100, such as demand planning and management 106, production sources 114, transportation and distribution management 110, etc.

We draw a broad outline of a scheme to illustrate realization of this flow dynamics approach. Some software details such as building this as a collection of libraries, and user interfaces etc., are not discussed in detail here to maintain focus on model realization, wherein building a general library collection and user interface is generally known in the art, with any one of various methods being utilized. Also, there are variations in supply chain and manufacturing processes that can impact the details of implementation such as the minimum lead time one would need to change the manufacturing/purchase of orders. These are important from practical perspective, but they do not alter the overall solution described herein.

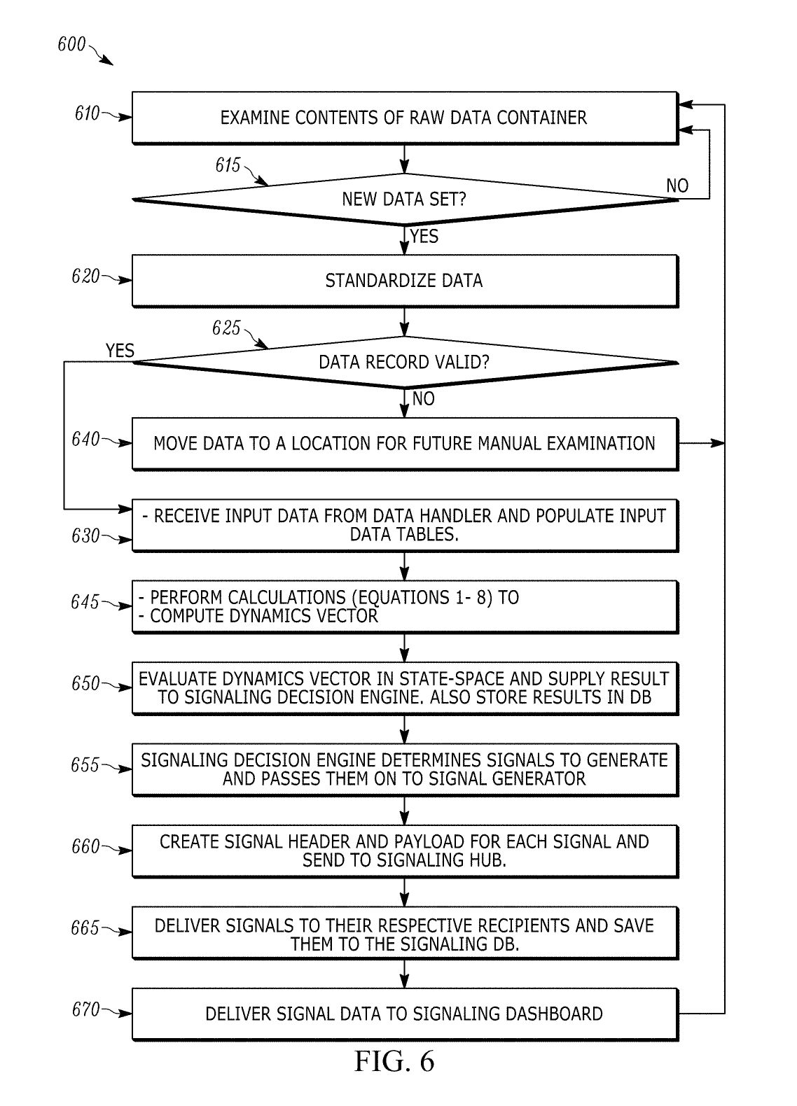

An exemplary calculation of the flow dynamics vector of a single product is provided below which is representative of the same approach used for other products. Using the notations defined earlier, let quantity q(t) be the KPI (known performance indicator) of interest. Then, the input is the arrival rates aᵢ(t) of the inflows (incoming) and the required measurements are: q(t), aᵢ(t) and μ(t). This data is available in some of the source system(s) in the supply chain, typically demand planning and management systems 106. This data typically gets updated often, at least daily by both vendor as well as the supply chain owners. Assuming that the processing needs to be done daily, the planned incoming data—POs, MOs (purchase and manufacturing orders) and shipments for the future dates are also brought in, along with the current data. This is an asynchronous process that gets data from the source systems into a temporary location, such as the raw data container 123. Either the source systems can push the data into the raw data container 123 or the data handler 124 pulls the data from the source systems. Once input data is available, it is standardized and loaded into the warehouse dynamics database 138, such as discussed in relation to FIG. 6 below.

Once the data is available, the flow dynamics vector 150 for this product must be computed—for the current day and the future days for which the projections are available. The computed parameters are: y(t) and h′(t). Equations (1) through (8) are used to compute the flow dynamics vector 150 for each day. Depending on the location of flow dynamics vector 150, the current and the future, in the state-space (zone-A through zone-I), pre-determined signals are sent out to the signaling hub 134, as further described relative to FIG. 6 below.

The signaling hub 134 forwards these signals to interested elements of the dynamic inventory control system 100, where it is assumed that a pre-established communication connection exists between signaling hub 134 and the various supply chain elements of the dynamic inventory control system 100 (e.g., demand planning and management 106, transportation and distribution management 110, and production sources 114). The control functions implemented by the supply chain elements can alter the production quantity and shipment to balance the dynamics. For example, a control function in demand planning domain can involve delaying delivery of a good, while for others it can a transfer of goods from one warehouse to another.

To further illustrate the process, FIG. 6 includes a flow chart 600 illustrating an exemplary method for providing dynamic inventory control. Flow chart 600 begins at step 610 where the raw data container 123 receives the customer consumption data 108 and communicates it to the data handler 124 for examination. Upon examination in step 615, the data handler 124 can reject the data record if it deems it a duplicate of previous data record, or can proceed to step 620, where data standardization can be performed. In step 625, the data handler 124 checks if the transformed data record is valid (e.g., does the data record include product IDs that correlate with product IDs found in the warehouse dynamics database 138, if not, the record set can be moved to a failed record set folder for future manual examination in step 640; otherwise the process proceeds to step 630 where the instantaneous dynamics calculator 120 receives the data record from the data handler 124 and populates a new or appends an existing data table (e.g., data table 500). In step 645, the values in the data table are augmented by applying equations (2) to (8) thereto, to generate the flow dynamics vector 150, which is communicated to the flow dynamics receiver 126. In step 650, the flow dynamics controller 122 receives the flow dynamics vector 150 and various thresholds for the product ID such as future scheduled product arrival dates and changes, if any, and evaluates the flow dynamics vector 150 in the context of the thresholds and figuratively places the flow dynamics vector in one of the nine zones of the state-space, communicating that information to the signaling decision engine 130, and/or the warehouse dynamics database 138. In step 655, the signaling decision engine 130 applies pre-established rules and thresholds to the flow dynamics vector to determine what signals should be generated, and communicates the signals to the signal generator 132. The pre-established rules and thresholds can be stored in any one of various databases, such as the signaling database 140. Such pre-established rules and thresholds can be determined from a prepared table of suggested signals used to inform various entities of suggested actions to correct deviations from an ideal inventory at the warehouse, such as noted above with regard to zones F and A.

At step 660, for each signal to be sent, the signal generator 132 prepares a message packet with one or more headers such as: ‘originator’, ‘creation time’, ‘expiry time’, ‘payload contents’, etc., as well as some relevant variable values from the warehouse dynamics database 138, such as the flow dynamics vectors, etc. These signals are then ready for transmission and the signal generator 132 sends these to the signaling hub 134. Signaling hub 134 maintains the topology of the various players in the supply chain eco-system (Fig A). How this topology is created is outside the scope of this work; However, prior art in this space exists. The signaling hub 134 may support peer-to-peer and/or publish-subscribe messaging paradigms and unicast, multi-cast and broadcast patterns

At step 660 the signal generator 132 generates the signal structures (e.g., header and payload) and sends the signals to the signaling hub 134. In step 665, the signaling hub 134 communicates the signals to their respective recipients, and to the signaling database 140. In step 670, the signaling database 140 can communicate the signals to the signaling dashboard 136, and the process 670, until the next set of raw data arrives.

Optimization of warehouse inventory assists with minimizing the cost of inventory as well as maintaining a desired balance for warehousing needs. The cost of inventory is measured in terms of days inventory is held in a warehouse. Not all units of an item are held for the same number of days. With non-perishable items, goods are not shipped out of the warehouse in a FIFO manner. On any given day, excess inventory is shelved. When more units arrive the next day, the recently arrived units get shipped (delivered to store or customer) first. Thus, some units can stay in the shelf for extended periods of time. In this scenario, counting the number of days each unit stays in the shelf results in erroneous latency calculation. Therefore, a computed value of average hold time (i.e., average latency) is to be maintained. Now we can calculate the cost of inventory on any specific day as: number of units of an item based on average latency, noting that often a monetary value is associated with the cost of inventory.

l(t)—Average latency of each unit held in the inventory at time ‘t’

y(t)—Congestion at time ‘t’

μ(t)—Consumption rate at time ‘t’

q(t)—Quantity of item at time ‘t’

Where q(t)=q(t−1)+y(t)−μ(t) (3)

For calculation purposes, we treat the flow as FIFO. The rationale is that we can allege that the most recently arrived items are the ones pulled off of the shelves for outflow from the warehouse 104 (basically imagined altering of arrival time stamps). Under this exemplary FIFO model, we assume that the warehouse ships out the carried over units first at outflow and then use that days' arrival as inflow.

### Case 1:

Condition: Consumption at ‘t’ is less than inventory carried over from ‘t−1’.

i.e. 0≦μ(t)≦q(t−1)

l(t)=([q(t−1)−μ(t)]×[l(t−1)+1]+y(t))/q(t) (9)

### Case 2:

Condition: Consumption at ‘t’ is more than inventory carried over from ‘t−1’.

i.e. μ(t)>q(t−1)

l(t)=([q(t−1)−μ(t)]+y(t))/(q(t) (10)

But, q(t−1)+y(t)−μ(t)=q(t)

Therefore, l(t)=1

We can combine these two and write as:

l(t)=(Max{[q(t−1)−μ(t)],0}×l(t−1)+[q(t−1)−μ(t)]+y(t))/(q(t))

l(t)=(Max{[q(t−1)−μ(t)],0}×l(t−1)+q(t))/(q(t))

l(t)=(Max{[q(t−1)−μ(t)],0}×l(t−1))/q(t)+1 (11)

It is specifically intended that the aforementioned method and system for dynamic inventory control not be limited to the embodiments and illustrations contained herein, but include modified forms of those embodiments including portions of the embodiments and combinations of elements of different embodiments has come within the scope of the following claims. In addition, the various methods described herein can include additional steps not described herein or can omit steps described herein. Further, the various steps can be performed in a different order than described herein. The use of the term “plurality” shall be understood to include one or more. Communication between the components described herein can occur via numerous known wired and wireless electronic communication methods, for example, cellular, Bluetooth, Wi-Fi, NFC, etc. The term, “or,” as used here, refers to a non-exclusive or, unless otherwise indicated. Further, although various computing and data processing machines, components, etc. have been specified with regard to one or more specific processes, it is to be understood that any portion of the above described process and apparatus can be performed individually or collectively on a particular machine, and includes any and all necessary hardware and software to perform the aforementioned process, wherein the computing and data processing methods, machines, components, etc. themselves are known in the art of electronics, such as processors, memory components, Programmable Logic Controllers (PLC), data storage elements (hard drives, ROM, RAM, Cloud, etc.), network cards, routers, servers, communication modules (Bluetooth, Wi-Fi, cellular, fiber optic cabling, cloud communications, etc.), wherein the standard interfacing of the components can be performed using various known communication and processing protocols and methods. In at least some embodiments, time notations such as time t, time t+1, time t−1, are considered a fixed point in time, whereas time intervals extend between these fixed points and can include a combination of such points.

What is claimed is:

1. A method for dynamic inventory control of a warehouse comprising:
receiving consumption data for a product at a data storage device, wherein the consumption data includes a product identification and a quantity of the product consumed in at a first time t;
standardizing the consumption data via one or more processing devices at a data handler to provide a data record, wherein the data handler verifies that the product ID correlates with a known product ID stored in a warehouse dynamics database;
receiving the standardized data record from the data handler at an instantaneous dynamics calculator;
at least one of populating or appending a data table with at least a portion of the data in the standardized data record, and wherein the data table includes a plurality of time dependent data values that include a beginning inventory quantity and an ending inventory quantity of the product stored in the warehouse at the first time t, wherein the beginning inventory quantity is equal to the ending inventory quantity of the product at a second time t−1;
calculating via one or more processing devices, a flow dynamics vector for the first time t using the data values in the data table, wherein the flow dynamics vector includes both a measure of magnitude of change in the inventory of the product and a direction of change in the inventory, where a positive direction of change indicates inventory growth and a negative direction of change indicates inventory shrinkage;
receiving the flow dynamics vector at a flow dynamics controller; and
generating via the one or more processing devices, a figurative state-space diagram that is divided into a plurality of zones by a plurality of threshold values related to the product, wherein the plurality of threshold values include a low consumption rate threshold and a high consumption rate threshold situated along a first axis of the state-space diagram, and a low normalized inventory quantity threshold and a high normalized inventory quantity threshold situated along a second axis of the state-space diagram, evaluating at the flow dynamics controller, the flow dynamics vector in the context of the thresholds to identify the zone indicated by the flow dynamics vector.

2. The method of claim 1, wherein the data values in the data table include the beginning inventory and ending inventory of the product stored in the warehouse, an incoming product quantity and outgoing product quantity at the first time t, wherein the incoming product quantity includes the sum of all products arrived into the warehouse from a plurality of product sources for the first time t, and the outgoing product quantity includes the sum of all products that have left the warehouse for the first time t.

3. The method of claim 2, wherein a height value representing a normalized incoming inventory flow of the product stored in the warehouse at the first time t is equal to a congestion value divided by the consumption, and wherein the congestion value includes the sum of all arrivals of incoming product into the warehouse for a first time interval extending between time t−a1 and time t.

4. The method of claim 3, wherein the first axis of the state-space diagram includes an inventory growth rate equal to the height value minus the numerical value of one.

5. The method of claim 4, wherein the data values in the data table further include the desired inventory quantity, comprising the quantity of product that is to be held in the warehouse during either of the first time interval or a second time interval, wherein the second time interval includes the duration of time extending between the first time t and a third time t+1.

6. The method of claim 5, wherein the data values in the data table further include the normalized quantity of inventory comprising the ending inventory quantity divided by the desired inventory quantity of the product.

7. The method of claim 6, wherein the flow dynamics vector includes the normalized inventory quantity at the first time t and the growth rate at the second interval, wherein the normalized inventory quantity is positioned on second axis of the state-space diagram axis, and the growth rate is positioned on the first axis to provide the position of the flow dynamics vector indication.

8. The method of claim 7 wherein the plurality of zones includes a first zone defined as being within the consumption rate and inventory quantity thresholds, and wherein indication of the flow dynamics vector inside the first zone is identified as an optimal consumption rate and inventory quantity.

9. The method of claim 8, wherein the plurality of zones further includes a second zone and a third zone defined as being within the normalized inventory quantity thresholds indicating optimal inventory quantity, and wherein the second zone is less than the low consumption rate threshold indicating inventory shrinkage, and the third zone is greater than the high consumption rate threshold indicating inventory growth.

10. The method of claim 9, wherein the plurality of zones further includes a fourth zone and a fifth zone defined as being within the consumption rate thresholds indicating optimal consumption rate, and wherein the fourth zone is less than the low normalized inventory quantity threshold indicating low but stable inventory quantity, and the fifth zone is greater than the high normalized inventory quantity threshold indicating high but stable inventory quantity.

11. The method of claim 10, wherein the plurality of zones further includes a sixth zone and a seventh zone defined as being below the low normalized inventory quantity threshold, and wherein the sixth zone is less than low consumption rate threshold indicating low and deteriorating inventory quantity, and the seventh zone is greater than the high consumption rate threshold indicating low and improving inventory quantity.

12. The method of claim 11, wherein the plurality of zones further includes an eight zone and a ninth zone defined as being above the high normalized inventory quantity threshold, and wherein the eight zone is less than low consumption rate threshold indicating high and improving inventory quantity, and the ninth zone is greater than the high consumption rate threshold indicating high and deteriorating inventory quantity.

13. The method of claim 8, wherein the product includes a physical article of manufacture, manufactured for purchase by a consumer, and stored in a physical warehouse.

14. The method of claim 13, further comprising:
identifying one or more signals to be generated in response to the zone indication, wherein the identification includes comparing the zone indication with a plurality of pre-established correlative signals for the product, and wherein the one or more signals can be chosen for one or more correlative recipients; and
generating the one or more signals and communicating to the one or more correlative recipients.

15. A method for dynamic inventory control of a warehouse comprising:
receiving consumption data for a product at one or more data storage devices, wherein the consumption data includes a product identification and a quantity of the product consumed in a first time t;
standardizing the consumption data via one or more processing devices to provide a data record, wherein the one or more processing devices verifies that the product ID correlates with a known product ID stored in an warehouse dynamics database;
receiving the standardized data record from the one or more processing devices and at least one of populating or appending a data table with at least a portion of the data in the standardized data record, and wherein the data table includes a plurality of time dependent data values that include a beginning inventory quantity and an ending inventory quantity of the product stored in the warehouse at the first time t, wherein the beginning inventory quantity is equal to the ending inventory quantity of the product at a second time t−1;
calculating via one or more processing devices, a flow dynamics vector for the first time t using the data values in the data table, wherein the flow dynamics vector includes both a measure of magnitude of change in the inventory of the product and a direction of change in the inventory, where a positive direction of change indicates inventory growth and a negative direction of change indicates inventory shrinkage;
generating via the one or more processing devices, a figurative state-space diagram that is divided into a plurality of zones by a plurality of threshold values related to the product, wherein the plurality of threshold values include a low consumption rate threshold and a high consumption rate threshold situated along a first axis of the state-space diagram, and a low normalized inventory quantity threshold and a high normalized inventory quantity threshold situated along a second axis of the state-space diagram, and evaluating at the flow dynamics controller, the flow dynamics vector in the context of the thresholds to identify the zone indicated by the flow dynamics vector;
identifying one or more signals to be generated in response to the zone indication, wherein the identification includes comparing the zone indication with a plurality of pre-established correlative signals for the product, and wherein the one or more signals can be chosen for one or more correlative recipients; and
generating the one or more signals and communicating the one or more signals to the one or more correlative recipients.

16. The method of claim 15, wherein the product includes a physical article of manufacture, manufactured for purchase by a consumer, and stored in a physical warehouse.
